(19) United States
(12) Patent Application Publication
(10) Pub. No.: US 2008/0077526 A1
(43) Pub. Date: Mar. 27, 2008

(54) ONLINE PAYER AUTHORIZATION SYSTEMS AND METHODS

(75) Inventor: Avin Arumugam, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/533,585

(22) Filed: Sep. 20, 2006

(51) Int. Cl. G06Q 40/00

(52) U.S. Cl. 705/44; 235/379

(57) ABSTRACT

An in-process payer authorization system is configured to host a merchant e-commerce web site and create a purchase transaction record based on a transaction with a customer. The purchase transaction record includes an account identifier of the customer. The system is also configured to render a first display screen on a computer of the customer that is configured to query whether the customer is registered for in-process payer authorization. The system is further configured to include information based on a response to the query in the transaction record and render a second display screen on the computer of the customer that is configured to receive a confirmation code from the customer. The system is also configured to locate an in-process payer authorization record that includes an electronic address of the customer, generate a random code relating to the purchase transaction, and send an electronic communication to the electronic address of the customer that includes the random code. The system is also configured to, while the transaction with the customer is in progress, receive the confirmation code from the server computer, compare the confirmation code to the random code, and, based on the comparison, determine whether to authorize the transaction.

Embodiments of the present invention relate generally to a payer authorization system for purchase transactions. More specifically, embodiments of the present invention relate to systems and methods for obtaining payer authorization of a transaction while the transaction is in process.

### BACKGROUND OF THE INVENTION

Online perchance transactions are becoming increasingly popular. Such transactions are almost exclusively settled using a credit or debit account. Because the presentation instrument (i.e., credit card) is not physically present for inspection by the online merchant to complete the transaction, such transactions are subject to a higher incidence of fraud. Merchants typically pay a higher rate (e.g., an interchange rate) for such transactions.

Moreover, presentation instrument holders also are at risk of having a credit card stolen. A stolen card may be used to complete online purchases before the card gets reported lost or stolen. Some online merchants protect themselves from such fraud by delaying shipment of merchandise purchased online, which is inconvenient for the customer. Customers, however, have few options to protect themselves from such fraud. Hence, for all the foregoing reasons, improved systems and methods are needed to reduce the incidence of fraud in online purchase transactions.

### BRIEF SUMMARY OF THE INVENTION

Embodiments of the present invention thus provide an in-process payer authorization system. The system includes a server computer that is configured to host a merchant e-commerce web site and create a purchase transaction record based on a transaction with a customer. The purchase transaction record includes an account identifier of the customer. The server computer is also configured to render a first display screen on a computer of the customer. The first display screen is configured to query whether the customer is registered for in-process payer authorization. The server computer is further configured to include information based on a response to the query in the transaction record and render a second display screen on the computer of the customer. The second display screen is configured to receive a confirmation code from the customer. The system also includes a host computer system that is configured to receive the transaction record from the server computer and locate an in-process payer authorization record relating to the customer. The in-process payer authorization record includes an electronic address of the customer. The host computer system is further configured to generate a random code relating to the purchase transaction and send an electronic communication to the electronic address of the customer. The electronic communication includes the random code. The host computer system is also configured to, while the transaction with the customer is in progress, receive the confirmation code from the server computer, compare the confirmation code to the random code, and, based on the comparison, determine whether to authorize the transaction. In some embodiments, the electronic address is an email address of the customer. The electronic communication may be an SMS message to a mobile phone number of the customer.

Other embodiments provide a method of processing a purchase transaction. The method includes, at a host computer system of a credit card processor, receiving a purchase transaction record from a merchant that includes an account identifier for a customer. The method also includes locating a record relating to the customer, which record identifies an electronic address for the customer. The method also includes generating a random code and sending an electronic message that includes the random code to the electronic address of the customer. The method also includes receiving a communication that includes a code from the customer via the merchant. The method also includes comparing the code in the communication to the random code, and, in response to the comparison, authorizing the purchase transaction.

In some embodiments, the electronic address is an email address of the customer. Sending an electronic message to the electronic address of the customer may include sending an SMS message to a mobile phone number of the customer. The method may include pre-registering the customer prior to the transaction. Pre-registering the customer may include receiving a request to register from the customer, which request includes at least the account identifier of the customer and the electronic contact address for the customer. Pre-registering the customer also may include verifying the electronic address of the customer. The method May include thereafter charging the merchant a reduced interchange rate for the purchase transaction. The method also may include thereafter shipping merchandise relating to the transaction to the customer at an expedited rate.

Still other embodiments provide a method of processing a purchase transaction. The method includes, at a server computer of an online merchant, receiving from a customer a selection of at least one item to be purchased by the customer, initiating a checkout process for the at least one item, and sending a transaction record relating to the purchase transaction to a host computer system of a transaction processor, which transaction request includes a presentation instrument account identifier of the customer. The method also includes using the account identifier to locate a record of the customer, which record includes an electronic address of the customer. The method further includes, at the host computer system of the transaction processor, generating a random code, sending an electronic message to the electronic address of the customer, wherein the electronic message includes the random code, and, while the checkout process is in progress, receiving a confirmation code from the customer at the merchant server. The method further includes sending the confirmation code from the merchant server to the host computer system of the transaction processor, at the host computer system of the transaction processor, comparing the confirmation code to the random code, and based on the comparison, authorizing the transaction.

Still other embodiments provide an in-process payer authorization system that includes means for creating a purchase transaction record based on a transaction with a consumer, which purchase transaction record includes an account identifier of the consumer, means for locating an electronic address of the consumer using the account identifier while the transaction is in process, means for generating a random code relating to the purchase transaction while the transaction is in process, means for transmitting the random code to the electronic address of the consumer, means for receiving a confirmation code from the consumer while the transaction is in process, means for comparing the confirmation code to the random code, and means for authorizing the transaction based on the comparison while the transaction is in process.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an online payer authorization system according to embodiments of the invention.

FIG. 2 illustrates a method of obtaining payer authorization during an online purchase transaction according to embodiments of the invention, which method may be implemented in the system of FIG. 1.

FIGS. 3A and 3B illustrate exemplary display screens that may be used to obtain payer authorization during an online purchase transaction according to embodiments of the invention.

### DETAILED DESCRIPTION OF THE INVENTION

Embodiments of the present invention relate to systems and methods for obtaining payer authorization during the course of an online purchase transaction. In order to provide a context for describing embodiments of the present invention, embodiments of the invention will be described herein with reference to using a credit card account to purchase merchandise over the Internet from an online merchant. Those skilled in the art will appreciate, however, that the systems and methods described herein may be applied to, for example, obtaining payer authorization during a telephone purchase or the like.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to embodiments of the present invention, an online merchant may obtain confirmation of payer (AKA, consumer or customer) authorization for a credit card (AKA presentation instrument) purchase transaction even thought the payer's credit card is not present. This is accomplished with the assistance of the merchant's credit card transaction processor, who sends a randomly-generated confirmation code to an electronic device of the payer while the payer is “checking out” from the merchant's online store. The payer then provides that code to the merchant, via, for example, a dialog box that pops up on the payer's computer screen while checking out from the merchant's online store. The code, as entered by the payer, is transmitted to the processor, and the transaction is completed if a match exists.

In a specific example of the present invention, the consumer/payer/card holder registers for the payer authorization service, in exchange for which an online merchant offers the customer, for example, expedited shipping on orders. The merchant provides this incentive to thereby receive lower transaction processing fees, chargeback protection, and/or the like from the merchant's credit card transaction processor. The transaction processor is able to provide this reduced rate, since the additional level of authorization reduces the risk that the transaction processor will have to incur the expense of a fraudulent transaction.

The customer may pre-register for the service prior to initiating a transaction or may register during the checkout process of a transaction. The registration process may require the customer to provide personal information not available on the customer's card to thereby establish the customer's identity for registration purposes. In other words, the registration process will include a level of security that would prevent a card thief from imitating the customer during the registration process. The customer also provides means for immediate contact with the customer, such as an email address or mobile phone number (AKA electronic address), to which the customer may receive a Short Message Service (SMS, or text message), email, or the like.

As the customer is completing the payment portion of the online transaction, the customer is queried whether he is registered in the payer authorization service. If not, he is given the opportunity to register, which he may decline. If the customer is registered or elects to register, completion of the payment portion of the transaction is suspended while the merchant's credit card transaction processor generates a random code and sends it to the customer by way of the electronic address the customer provided. When the customer receives the random code, the customer inputs the code into a transaction processing window and completes the payment process. The transaction is completed only if the random code matches the code generated by the transaction processor. Of course, all other relevant portions (account number, credit card expiration date, billing zip code, name on card, etc.) of a typical transaction must match as well.

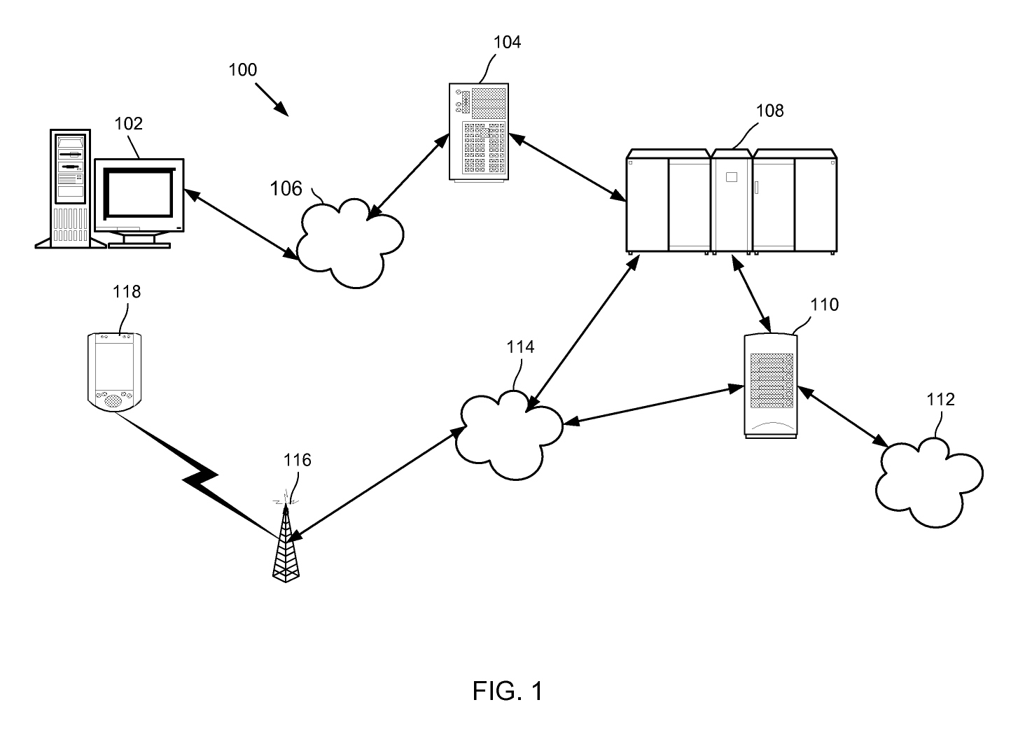

Having described embodiments of the present invention generally, attention is directed to FIG. 1, which illustrates an exemplary system 100 according to embodiments of the invention. Those skilled in the art will appreciate that the system 100 is merely exemplary of a number of possible embodiments. For example, the system 100 relates to an online merchant, but other exemplary systems may relate to a merchant having a telephone ordering system.

According to this exemplary embodiment, a customer, using a customer computing device 102, is communicating with an online merchant 104 via a network 106, such as the Internet. The online merchant may be, for example, a server connected to the Internet, which server hosts an e-commerce web site of the merchant. In ways known to those skilled in the art, the customer selects merchandise or services for purchase from the merchant and initiates a checkout process. At an appropriate point in the checkout process (e.g., after the customer has provided a credit card number), the merchant's online checkout system queries the customer whether the customer has enrolled in “in-process payer authorization.” (Those skilled in the art will appreciate that the use of the term “in-process payer authorization” is not intended to be limiting. Herein the term will be used broadly to refer to any process that implements any embodiments of the present invention.) As will be explained in greater detail hereinafter, the customer will be given the opportunity to register if he has not already done so. For purposes of describing this exemplary system embodiment, however, it will be assumed that the customer has registered for in-process payer authorization.

Once the customer acknowledges having registered for in-process payer authorization, the online merchant 104 sends a transaction record to the merchant's credit card transaction processor 108. The transaction record may include an indication that the customer has registered for in-process payer authorization and wishes to use that service in completing the current transaction. If so, the transaction processor 108 uses this information to locate a record relating to the customer, which record includes the electronic address of the customer. The transaction processor also may generate a random code for transmission to the customer as part of the in-process payer authorization.

The customer's in-process payer authorization record, that includes the customer's electronic address, may reside in any of several locations. In some embodiments, the record is maintained by the merchant's credit card transaction processor 108. This may be the case, for example, if the processor 108 is also the processor for the entity that issued the customer his credit card (i.e., issuer). In other embodiments, however, the processor 108 may have to communicate via a gateway 110 to a credit card transaction processing network 112, which may be any of the many well known transaction processing networks. The customer's in-process payer authorization record may reside at the gateway 110 or at any of a number of locations throughout the credit card transaction processing network 112. Those skilled in the art will appreciate that many possibilities exist.

Having located the customer's record and associated electronic address, the transaction processor 108, in some embodiments, sends the transaction record to the gateway 110. The transaction record includes the random code. In these embodiments, the gateway 110 may contact the customer for authorization, as will be described. In other embodiments, the transaction processor 108 may contact the customer for payer authorization as will be described.

Continuing with a description of the illustrated embodiment, while the customer is checking out of the merchant's online store, the gateway 110 contacts the customer using the customer's electronic address. In this embodiment, the contact is made through a communication network 114, which may be the Internet, a Public Switched Telephone Network (PSTN), and/or the like. The network 114 may communicate with the customer through a wireless link 116.

In some embodiments, the communication is an email to the customer. In other embodiments, the communication is a SMS message to the customer. In any case, the communication includes the random code. The customer may receive the communication on any of a variety of devices 118, including wired (e.g., a personal computer), or wireless (e.g., cell phone, PDA, etc.) devices. Once the customer receives the communication that includes the random code, the customer enters a confirmation code into an appropriate space in the checkout portion of the merchant's web site (e.g., a dialog box). As will be described, in completing the transaction, the merchant 104 forwards the confirmation code to the transaction processor 108 for comparison to the random code, and the transaction is completed if the codes match.

As mentioned previously, the foregoing is but one exemplary system 100 according to embodiments of the invention. For example, in an alternative embodiment, the transaction processor 108 maintains the in-process payer authorization record for the customer. The transaction processor 108 acquires the customer's electronic address from the record, generates the random code, and SMS-messages the code to a cell phone or PDA of the customer. This all takes place before any communication is made from the transaction processor 108 to the gateway 110 and/or transaction processing network 112. Those skilled in the art will appreciate that many other possible embodiments exist.

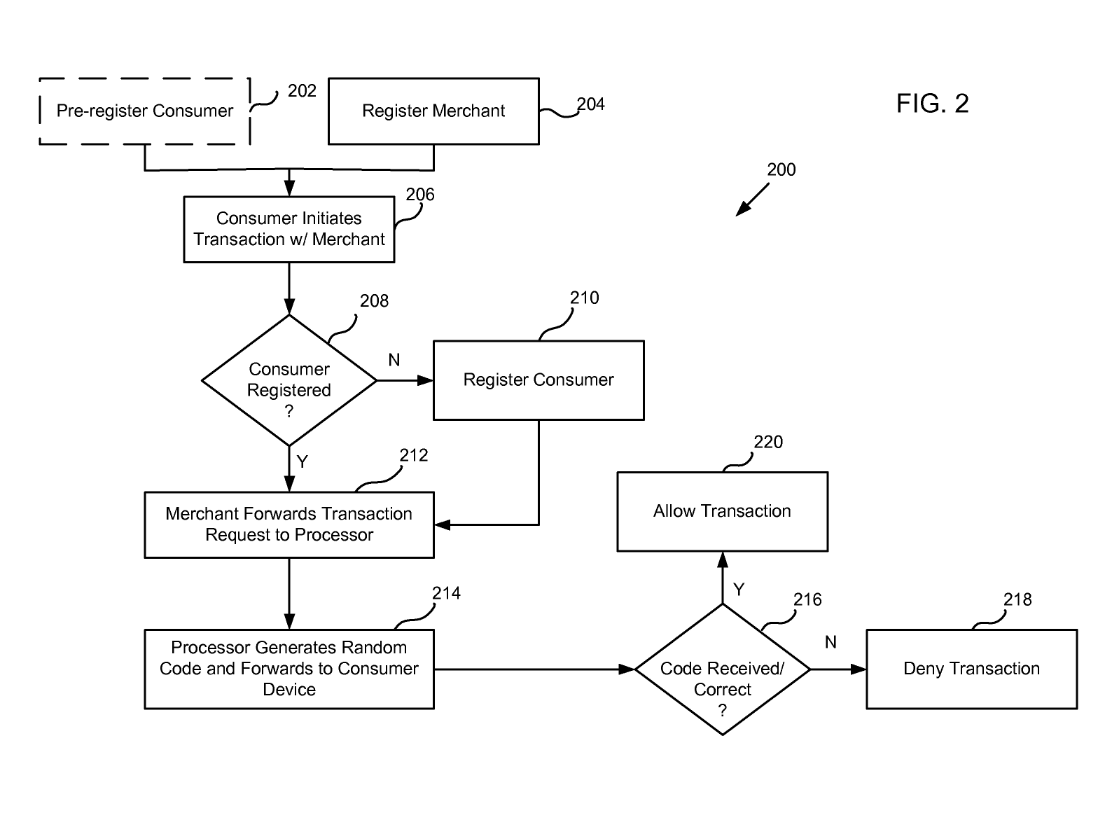

Having described exemplary system embodiments, attention is directed to FIG. 2, which illustrates an exemplary method 200 according to embodiments of the invention. The method 200 may be implemented in the system 100 of FIG. 1 or other appropriate system. Those skilled in the art will appreciate that other methods according to other embodiments may have more, fewer, or different blocks than those illustrated and described here. Further, those skilled in the art will appreciate that other methods according to other embodiments may traverse the steps illustrated and described herein in a different order than that depicted.

The method 200 begins with the optional block 202 of pre-registering a consumer (AKA, payer, customer, card holder) to participate in in-process payer authorization. Any of a variety of entities may offer a consumer/card holder an opportunity to register for the service. For example, an online merchant may offer a frequent customer the opportunity to receive expedited shipping if the customer enrolls in and uses in-process payer authorization for purchases at the merchant's web site. The card holder's processor also may offer the card holder the opportunity to enroll as a means for the customer to provide better security for the card holder's credit card.

In pre-registering, the card holder creates a record with a credit card transaction processor, such as the processor 108 of FIG. 1. The transaction processor may be the card holder's transaction processor, although this is not a requirement. The card holder may be required, however, to provide information, for security purposes, that confirms the card holder's identity. In completing the pre-registration process, the card holder provides an electronic address (e.g., email address, cell phone number, etc.) to which in-process payer authorization messages may be directed.

At block 204, a merchant is registered to provide in-process payer authorization to its customers. This may include a transaction processor working with the merchant to code appropriate procedures into the merchant's web site checkout process. A merchant may be offered a fee reduction (e.g., a lower “interchange fee,” transaction processing fee, and/or the like) for transactions in which a consumer provides in-process payer authorization.

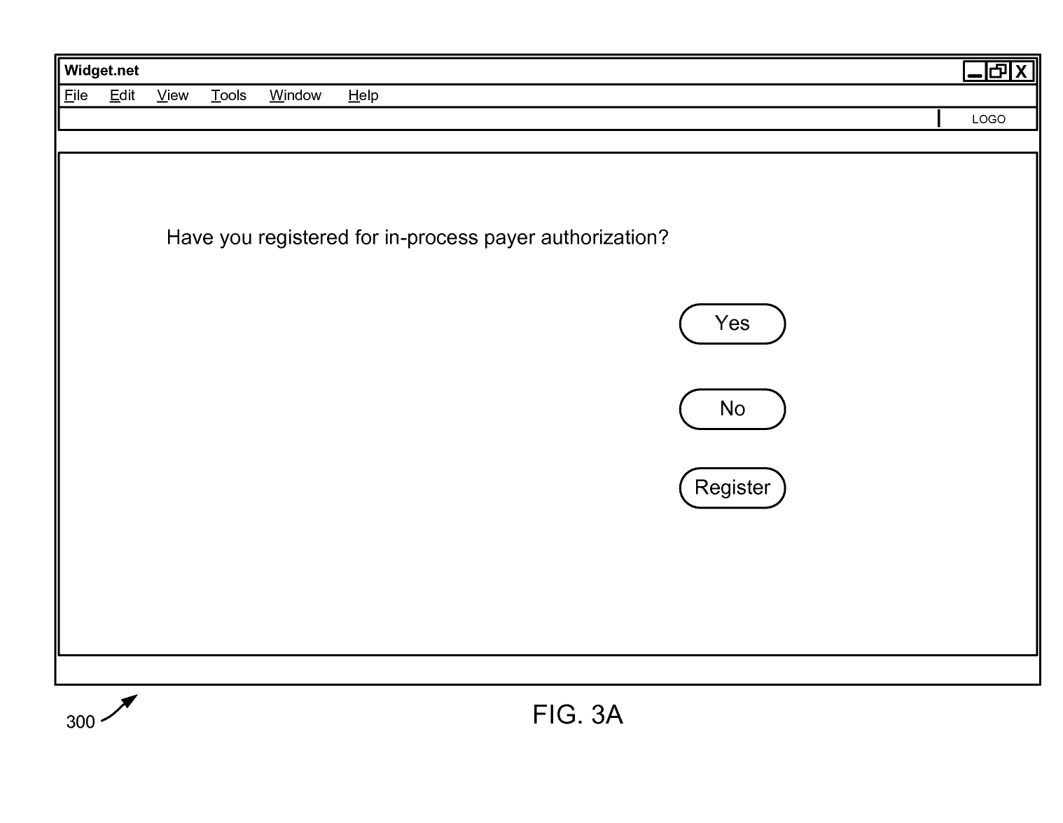

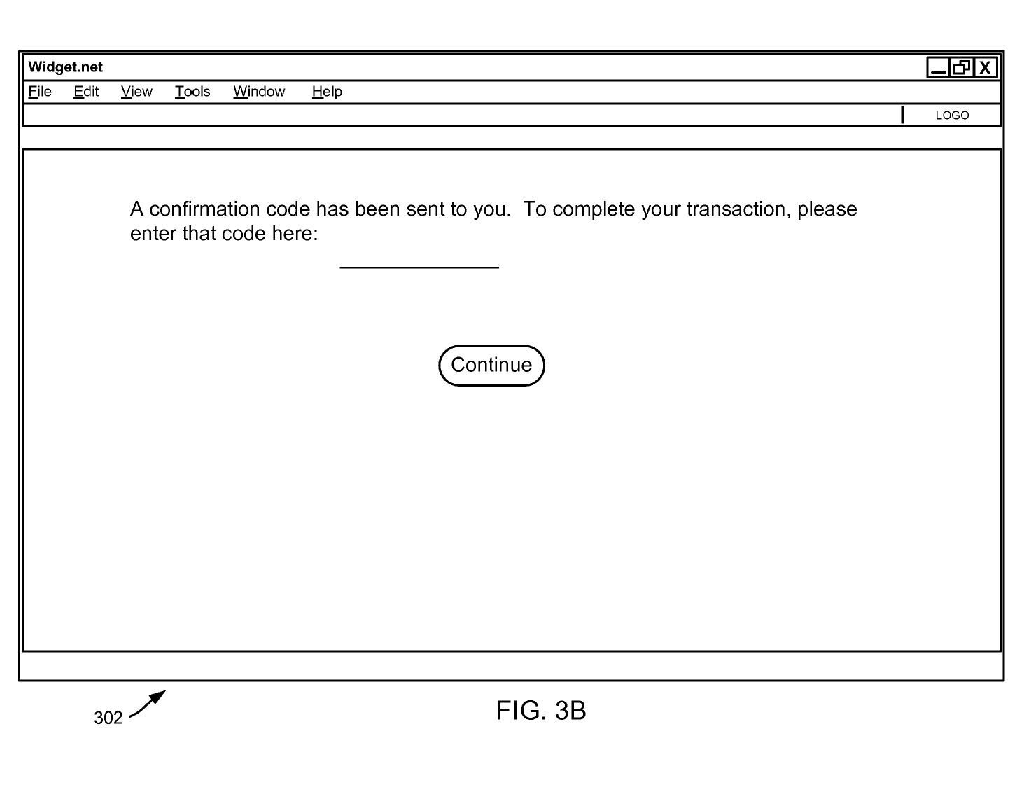

At block 206, a consumer initiates a transaction with a registered merchant. At an appropriate point in the checkout process (block 208), a determination is made whether the consumer is registered with in-process payer authorization. This may be accomplished by rendering a display screen, such as the display screen 300 of FIG. 3A, on the consumer's computer. By selecting an appropriate button, the consumer is given an opportunity to register at block 210. Registration at block 210 is substantially similar to consumer pre-registration discussed previously at block 202. If the consumer is already registered and elects to use in-process payer authorization for the current transaction, the process continues at block 212.

At block 212, the merchant forwards a transaction request to the merchant's credit card transaction processor. The transaction request includes an indication that the consumer intends to use in-process payer authorization for the current transaction. In this specific embodiment, an in-process payer authorization record relating to the consumer resides with the transaction processor, and the transaction processor uses the transaction request to locate the record. The record includes an electronic address for the consumer. The transaction processor then generates a random code and sends the code to a communication device (e.g., cell phone, PDA, personal computer, etc.) of the consumer. This takes place at block 214.

In response to a display screen rendered on the consumer's computer, such as the display screen 302 of FIG. 3B (which may be a popup window or dialog box), the consumer submits a confirmation code to the merchant. The confirmation code is passed through to the merchant's transaction processor, possibly as part of a transaction authorization or as part of a completed transaction request. At block 216 a decision is made whether the confirmation code provided by the consumer matches the random code generated by the transaction processor. If not, the transaction is denied at block 218. If, however, the confirmation code is received by the transaction processor and matches the random code the transaction processor generated, then the transaction is allowed at block 220.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Moreover, those skilled in the art will appreciate that the concepts discussed herein may be directed toward other types of “card not present” transactions, such as telephone purchases (mail order/telephone order, AKA “MOTO”) and the like. Accordingly, the above description should not be taken as limiting the scope of the invention, which is defined in the following claims.

What is claimed is:

1. An in-process payer authorization system, comprising:
a server computer configured to:
host a merchant e-commerce web site;
create a purchase transaction record based on a transaction with a customer, wherein the purchase transaction record includes an account identifier of the customer;
render a first display screen on a computer of the customer, wherein the first display screen is configured to query whether the customer is registered for in-process payer authorization;
include information based on a response to the query in the transaction record; and
render a second display screen on the computer of the customer, wherein the second display screen is configured to receive a confirmation code from the customer;
a host computer system configured to:
receive the transaction record from the server computer;
locate an in-process payer authorization record relating to the customer, wherein the in-process payer authorization record includes an electronic address of the customer;
generate a random code relating to the purchase transaction;
send an electronic communication to the electronic address of the customer, wherein the electronic communication includes the random code;
while the transaction with the customer is in progress, receive the confirmation code from the server computer;
compare the confirmation code to the random code; and
based on the comparison, determine whether to authorize the transaction.

2. The system of claim 1, wherein the electronic address comprises an email address of the customer.

3. The system of claim 1, wherein the electronic communication comprises an SMS message to a mobile phone number of the customer.

4. A method of processing a purchase transaction, comprising:
at a host computer system of a credit card processor, receiving a purchase transaction record from a merchant, wherein the purchase transaction record includes an account identifier for a customer;
locating a record relating to the customer, wherein the record identifies an electronic address for the customer;
generating a random code;
sending an electronic message to the electronic address of the customer, wherein the electronic message includes the random code;
receiving a communication from the customer via the merchant, wherein the communication includes a code;
comparing the code in the communication to the random code; and
in response to the comparison, authorizing the purchase transaction.

5. The method of claim 4, wherein the electronic address comprises an email address of the customer.

6. The method of claim 4, wherein sending an electronic message to the electronic address of the customer comprises sending an SMS message to a mobile phone number of the customer.

7. The method of claim 4, further comprising, pre-registering the customer prior to the transaction, wherein pre-registering the customer comprises:
receiving a request to register from the customer, wherein the request includes at least the account identifier of the customer and the electronic contact address for the customer; and
verifying the electronic address of the customer.

8. The method of claim 4, further comprising, thereafter charging the merchant a reduced interchange rate for the purchase transaction.

9. The method of claim 4, further comprising, thereafter shipping merchandise relating to the transaction to the customer at an expedited rate.

10. A method of processing a purchase transaction, comprising:
at a server computer of an online merchant, receiving from a customer a selection of at least one item to be purchased by the customer;
initiating a checkout process for the at least one item;
sending a transaction record relating to the purchase transaction to a host computer system of a transaction processor, wherein the transaction request includes a presentation instrument account identifier of the customer;
using the account identifier to locate a record of the customer, wherein the record includes an electronic address of the customer;
at the host computer system of the transaction processor, generating a random code;
sending an electronic message to the electronic address of the customer, wherein the electronic message includes the random code;
while the checkout process is in progress, receiving a confirmation code from the customer at the merchant server;
sending the confirmation code from the merchant server to the host computer system of the transaction processor;
at the host computer system of the transaction processor, comparing the confirmation code to the random code; and
based on the comparison, authorizing the transaction.

11. The method of claim 10, wherein the electronic address comprises an email address of the customer.

12. The method of claim 10, wherein sending an electronic message to the electronic address of the customer comprises sending an SMS message to a mobile phone number of the customer.

13. The method of claim 10, further comprising, thereafter charging the merchant a reduced interchange rate for the purchase transaction.

14. The method of claim 10, further comprising, thereafter shipping the at least one item to the customer at an expedited rate.

15. The method of claim 10, further comprising, pre-registering the customer prior to the transaction, wherein pre-registering the customer comprises receiving a request to register from the customer, wherein the request includes at least the account identifier of the customer and the electronic address of the customer.

16. An in-process payer authorization system, comprising:
means for creating a purchase transaction record based on a transaction with a consumer, wherein the purchase transaction record includes an account identifier of the consumer;
means for locating an electronic address of the consumer using the account identifier while the transaction is in process;
means for generating a random code relating to the purchase transaction while the transaction is in process;
means for transmitting the random code to the electronic address of the consumer;
means for receiving a confirmation code from the consumer while the transaction is in process;
means for comparing the confirmation code to the random code; and
means for authorizing the transaction based on the comparison while the transaction is in process.

17. The method of claim 16, wherein the means for transmitting the random code to the electronic address of the consumer comprises means for sending an SMS message to a mobile phone of the consumer.

18. The method of claim 16, further comprising means for shipping an item relating to the transaction to the consumer at an expedited rate.

19. The method of claim 16, further comprising means for charging the merchant a reduced interchange rate for the purchase transaction.

20. The method of claim 16, further comprising means for pre-registering the customer prior to the transaction, wherein pre-registering the customer comprises receiving a request to register from the customer, wherein the request includes at least the account identifier of the customer and the electronic address of the customer.
